(19) United States
(12) Patent Application Publication
(10) Pub. No.: US 2006/0101415 A1
(43) Pub. Date: May 11, 2006

(54) Service logic program tracing

(76) Inventors: Mark S. Evans, Plano, TX (US); Alan L. Gerhardt, Pittsburg, TX (US); Warner Lee Hines, Southlake, TX (US); Robert L. Reeves, Plano, TX (US); Raymond M. Parker, Carrollton, TX (US); Paul D. Schepers, Frisco, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/978,667

(22) Filed: Nov. 1, 2004

(51) Int. Cl. G06F 9/44

(52) U.S. Cl. 717/128

(57) ABSTRACT

Systems, methods, and devices are provided for tracing a program such as a service logic program (SLP). One method embodiment includes accessing a conditional associated with a trace category and testing the conditional before making a tracing system call.

In an intelligent network (IN) services are separated from switching equipment and organized in a system such that network providers do not have to perform major modifications on multiple switches when a new service is introduced. IN development involves providing separate service data to databases outside of switching equipment nodes. Service logic programs (SLPs) are similarly separated outside of the switching equipment nodes to provide various enhanced services. Protocols are defined to permit interaction between switching systems and the intelligent nodes which contain the separated service logic and data.

Computing devices, e.g., devices having processor and memory resources, are used as “network devices” to perform various roles and tasks within the above described INs. These “network” devices include an operating system layer and an application program layer. The operating system layer includes a “kernel”. The kernel is a master control program that runs the computing device. The kernel provides functions such as task, device, and data management, among others. The application layer includes application programs, e.g., SLPs, that perform particular tasks. The application layer is referred to as being in “user space”, while the operating system layer can be referred to as “kernel space”. As used herein, “user space” implies a layer of code which is less privileged than the layer of code which is in the operating system layer or “kernel space”.

Many applications, or processes, may be running at the same time on a computing device. In programming parlance, a process refers to a running program which has a state and may have an input and output. Each process has one or more threads. A thread is an executable set of instructions being executed on a processor. A process contains attributes shared by all executing threads in the process, such as an address space, file descriptors, variables of an executing instance of a program, etc. As used herein, an SLP instance can be associated with a user level thread for a user level program or application.

The kernel manages the set of processes such that each process is provided with processor cycles. The kernel provides a set of services, referred to as “system calls” to allow the “user space” processes to interact with the “kernel”. In a system call, a user level process calls a routine in the kernel (system) to undertake some specific task. A system call can be expensive in terms of lines of program coding and processor time used.

To create programs for INs, software developers write source code in a programming language such as C/C++, COBOL, etc. Developers write source code to include assertions, PRT (print) statements, trace routines, etc., to be used in conjunction with debugging and/or troubleshooting the executable program, e.g., an SLP. For example, as programs are compiled and/or tested, assertions placed in the code are checked to verify conditions always believed to be true. PRT statements are used to write state information to a log file. And, trace routines/procedures can be used to allow different types of data to be traced and provide diagnostic information to a system user relating to an executing program.

Tracing routines prove useful both in a development environment and in the customer's run time environment for identifying issues existing with executable programs. For example, in a Unix environment TRACE routines can trace and record various traceable categories such as TRACE_CHARPUT (to trace all character outputs), TRACE_ORDINARY (to trace all update actions), TRACE_IEVENT (to trace low-level input processing, including timeouts), etc. The inclusion of assertions, PRT statements, and trace routines can provide diagnostic information to resolve issues with executable code, e.g., to help catch bugs and detect invalid states of execution in a program. A piece of code including assertions, PRT statements, trace routines, etc., e.g., code in a compiled program module, can be expressed as functions or variables (collectively “symbols”). For example, a TRACE symbol can be defined by a software developer while writing source code to trace different types of data.

Previous approaches for troubleshooting an SLP program have been to embed PRT statements that write state information to a log file. These PRT statements were embedded directly in callable TRACE procedures which would contain the test for whether tracing of a particular trace category was enabled. Previous approaches also involve the operation of ANDing a bitmask prior to a decision test. According to this methodology, a given TRACE procedure unconditionally performs a system call, prior to a decision test for whether a tracing routine is even enabled in the program. That is, the test for whether a test category was enabled is buried within the called trace procedures. This technique also needs the ANDing operation each time the trace procedure executes. The regimented system call and ANDing operation can be expensive in terms of lines of program coding and processor time used. For example, the system call itself creates overhead by way of the values (parameters) that are passed to the trace function.

Presently, the overhead of PRT statements embedded in callable TRACE procedures (e.g., to indicate whether a tracing routine is enabled) is substantial and not acceptable for normal operation of certain programs once deployed in the customer's run time environment, e.g., with SLPs executing in a service control point (SCP) for a wireless telecommunications network. Further, while PRT statements for the finished program can be disabled by a build option in the development environment, disabling the PRT statements removes their utility for other roles associated with troubleshooting programs in the customer environment.

### BRIEF DESCRIPTION OF THE DRAWINGS

FIG. 1 is a block diagram of a computer system suitable to implement embodiments of the invention.

FIG. 2A illustrates an example “if-then” logic statement.

FIG. 2B illustrates an embodiment a trace symbol represented by a predefined bit string and associated with a logical statement.

FIG. 2C illustrates an example embodiment of a DDL based structure having a number of trace categories.

FIG. 2D is an example embodiment of a logic statement as can be used for testing a trace category conditional, in association with the identified trace symbol embodiment of FIG. 2A and the DDL embodiment of FIG. 2C, in advance of executing a system call for a tracing routine.

FIG. 3A is a block diagram of a software development system suitable for creating program embodiments described herein.

FIG. 3B is a flowchart illustrating the continuance of a programs life cycle from the development environment in FIG. 3A to actual use in customer environment.

FIG. 4 is an example system illustration such as for a wireless telecommunications network showing the interaction between a number of network functions and service functions which can include program embodiments as described herein.

### DETAILED DESCRIPTION

Embodiments of the present invention provide for handling trace routines in a program. One method embodiment includes associating a conditional with a trace category in the program. The conditional is to test whether a tracing is enabled for the trace category. The method includes checking the conditional before making a trace procedure system call associated with the trace category. In various embodiments the conditional is embedded with the trace category using a hybrid graphical/text language such as a SLEL in SDL (service logic execution language (SLEL) in specification and description language (SDL)).

Embodiments include a program, such as an SLP executable on a computer device and/or network, where the program executes to access a conditional associated with a trace category, and tests the conditional before making a trace procedure system call. A given trace category may have its associated trace routine either “enabled” or “disabled” (“on” or “off”) by a system user. The status of whether the trace routine associated with a given trace category is indicated by a bit setting. The bit setting associated with the trace category can be dynamically changed by the system user at both system start up and on demand. The conditional associated with the trace category checks the bit setting of a given trace category before executing a system call.

In various embodiments, an SDL tool is employed in the program development and compilation process. The SDL tool can be used in connection with creating conditionals for various trace categories. Computer executable instructions provided to the SDL tool, execute to associate conditionals written in an SLEL in SDL language to various trace categories. A program, such as an SLP, is written by a program developer to include tracing logic. Program embodiments execute to test a conditional before making a trace procedure system call.

Computer System

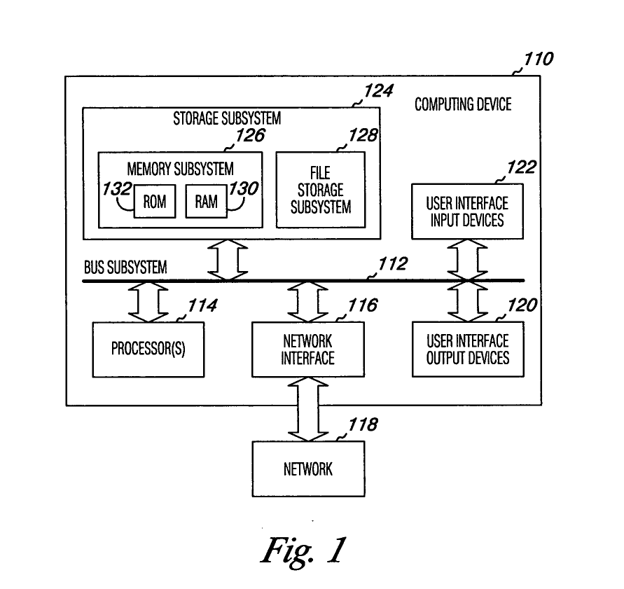

FIG. 1 is a block diagram of a computer system 110 suitable to implement embodiments of the invention. Computer system 110 includes at least one processor 114 which communicates with a number of other computing components via bus subsystem 112. These other computing components may include a storage subsystem 124 having a memory subsystem 126 and a file storage subsystem 128, user interface input devices 122, user interface output devices 120, and a network interface subsystem 116, to name a few, as the same will be appreciated by one of ordinary skill in the art. Network interface subsystem 116 provides an interface to outside networks, including an interface to network 118 (e.g., a local area network (LAN), wide area network (WAN), Internet, and/or wireless network, among others), and is coupled via network 118 to corresponding interface devices in other computer systems. Bus subsystem 112 provides a mechanism for letting the various components and subsystems of computer system 110 communicate with each other as intended. Program embodiments described herein can be executed on a computing device or system such as illustrated in FIG. 1.

Logic Statements

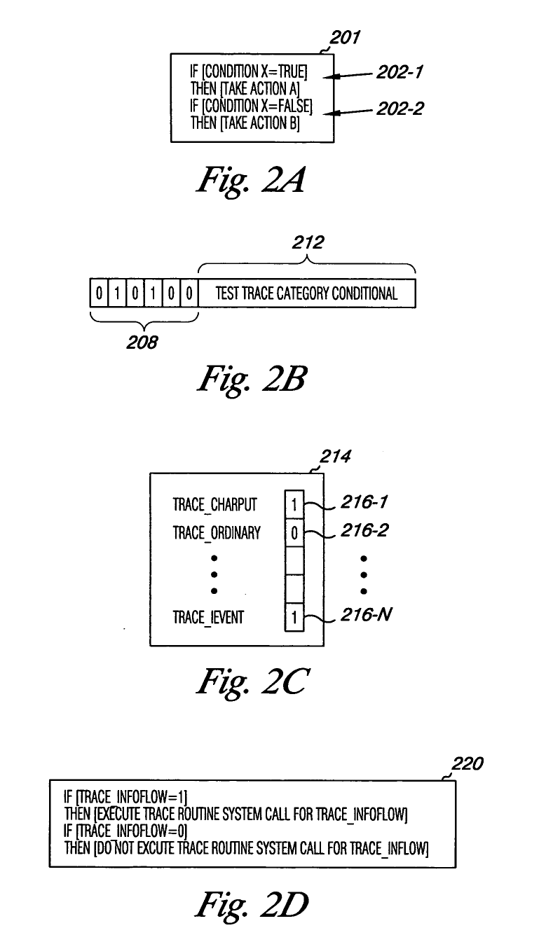

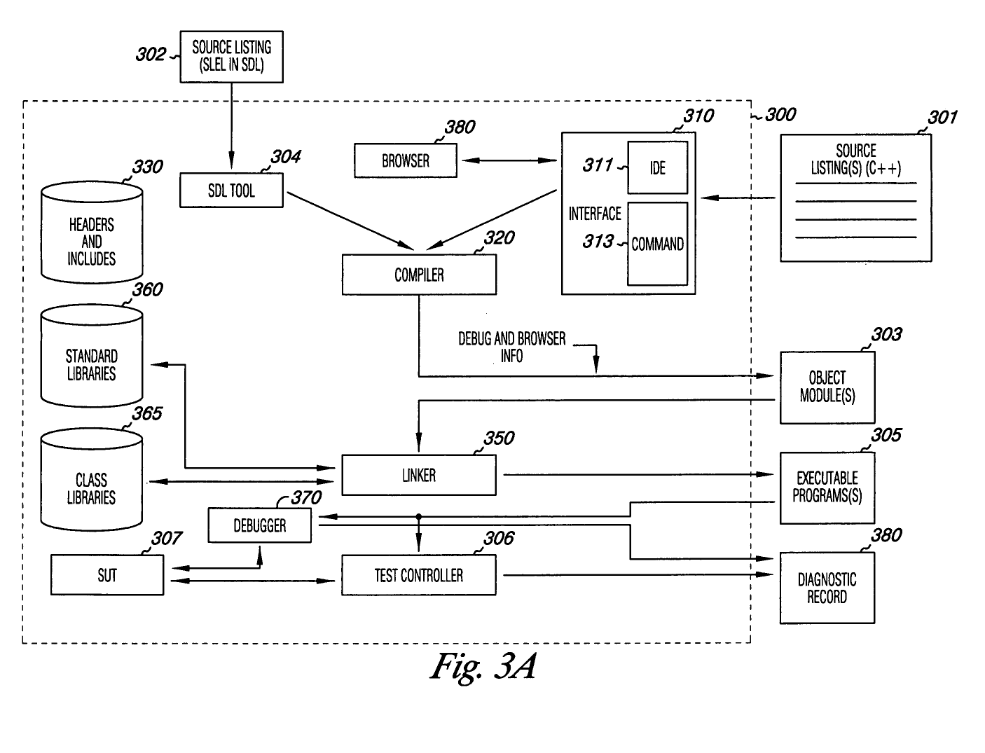

According to embodiments of the present invention, source code (also referred to as “source listings”) is written by a software developer to embed tracing logic, e.g., logic statements, in a program, e.g., an SLP. The tracing logic described herein includes conditionals which are associated with trace categories (discussed with FIG. 2B). The conditionals provided herein remain in the program once it is deployed in a customer's run time environment. As shown in FIG. 2A, one type of logical statement is an “if-then” statement where a condition (or conditional) is presented and if met, an action is performed (i.e., if [condition], then [action]). If then logical statements can be arranged in a series structure (e.g., if one condition is met, an action occurs, and if an action occurs another condition is met and another action occurs) and/or in a parallel structure, (e.g., an action will be taken regardless of the outcome of the conditional). Embodiments of the present invention

In the example of FIG. 2A, two if-then statements, 202-1 and 202-2, are illustrated in a parallel logical control structure 201. That is, the first if-then statement illustrates that “If [condition X=true], then [take action A]. The reader will appreciate that a given action can include the execution of a particular set of computer executable instructions, e.g. a routine. The second if-then statement illustrates that “If [condition X=False], then [take action B]. In this example, the logic control structure 201 first checks the conditional (in the first set of brackets) and if the conditional is met, e.g., condition X=true, the action (in the second set of brackets) is initiated, e.g., to take action A. However, as shown in FIG. 2A, if the conditional is not met, e.g., condition X=False, the action in the second if-then statement, e.g., take action B, is performed.

One of ordinary skill in the art will appreciate that logic statements themselves are performed by the execution of binary code, e.g., machine language instructions, and that an indication of whether a certain conditional is “true” or “false” can be determined by a bit status as either a one (1) or a zero (0). Further, it is noted that binary code can be expressed as functions or variables (collectively “symbols”). A function is a self-contained software routine that performs a task and a variable is a programming structure that holds data, i.e., bits. A variable holds the data assigned to it until a new value is assigned or the program is finished.

The execution of instructions to resolve whether a given conditional is true or false can involve testing the Boolean value of a member variable in a data description language (DDL) programming structure. As one of ordinary skill in the art will appreciate, DDL is a language used to define data and their relationships to other data, e.g. the relationship of between the statement “condition X” and the data indicating “true” or “false”. In the computing arts, Boolean algebra is used to represent the truth value of statements as either a 1 or 0. Thus, as used herein the term “member variable” is intended to mean the bit setting 1 or 0 and the “Boolean value” is intended to mean the association of this variable bit setting (representing true or false) to a given conditional statement, e.g., condition X. Also, as used herein, providing an if-then logic statement is referred to as “bracketing” a decision symbol, since the functions and variables are placed in brackets when writing the source code. The above example can be referred to as bracketing a single decision symbol since only one conditional is tested, albeit with different outcomes based on the result.

Embodiment for a Trace Symbol Associated with Logic Statement

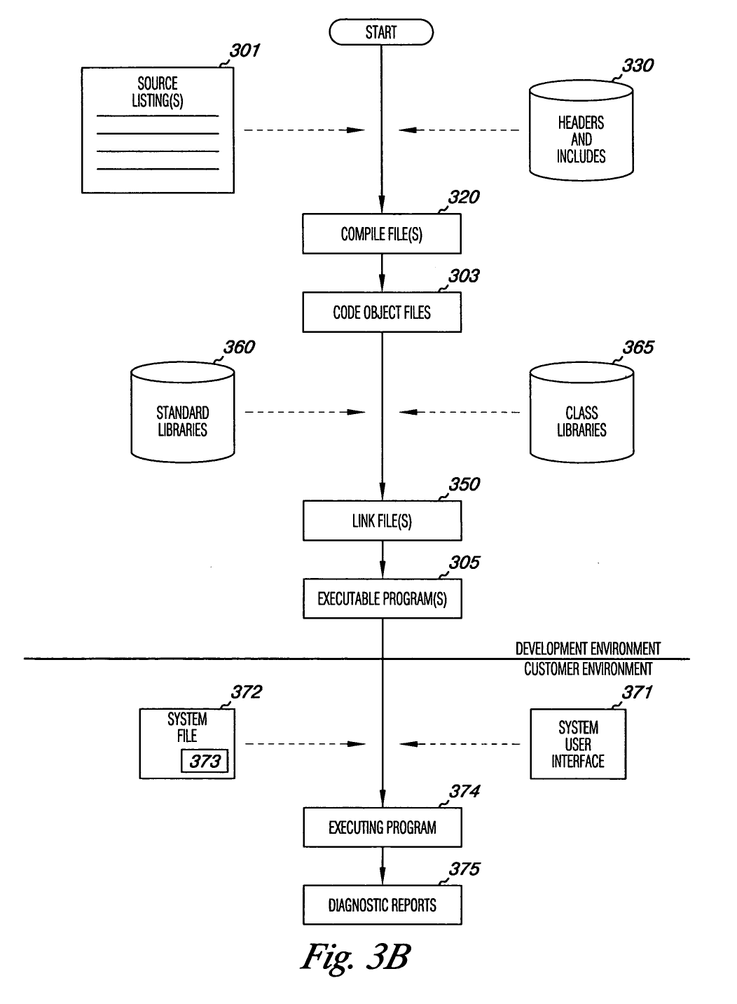

According to embodiments of the present invention, a software developer writes source code (as shown in FIGS. 3A and 3B) to define one or more TRACE symbols and denoting different trace categories in association with trace routines for those various trace categories. FIG. 2B provides an example embodiment of a trace symbol 208 represented by a predefined bit string, e.g., defined while writing the source code. The predefined bit string 208 allows the executing routine to access an appropriate trace category and an associated bit mask, e.g., in a DDL based structure (discussed with FIG. 2C), without having to perform an ANDing operation. The bit value associated with the trace category indicates whether a tracing routine for that category is enabled. Using the predefined bit string 208 to access a DDL based structure rather than performing an ANDing operation, i.e., ANDing (Trace Flags, Bit Mask), conserves coding and system resources. As shown in the example embodiment of FIG. 2B, the trace category 208 is associated with a logical statement (represented in block form as 212) which executes instructions to test a conditional (described in FIG. 2D) associated with a particular trace category as identified by the predefined bit string 208.

Embodiment for a DDL Based Structure

FIG. 2C illustrates an example embodiment of a DDL based structure 214 having a number of trace categories. In FIG. 2C the example trace categories illustrated include a TRACE_CHARPUT category (i.e., to trace all character outputs), a TRACE_ORDINARY category (i.e., to trace all update actions), and a TRACE_IEVENT (i.e., to trace low-level input processing, including timeouts) as may be used in a Unix operating environment. Embodiments of the invention, however, are not limited to these example trace category types and/or to the number of trace categories included in the DDL as part of a trace control structure. The DDL embodiment of FIG. 2C represents a number of member variables, 216-1, 216-2, . . . , 216-N, associated with each TRACE category contained therein. In the embodiment of FIG. 2C each member variable is illustrated as a bit representing a 1 or a 0 to indicate whether a trace routine associated with a given trace category has been enabled, e.g., 1 (true) or 0 (false). The designator “N” is used to indicate that a number of trace categories with associated member variables can be included in the DDL 214.

According to embodiments described herein, program instructions can execute to check the bit value, 216-1, 216-2, . . . , 216-N, associated with a given trace category in the DDL 214, i.e., test a Boolean value of a member variable in the DDL based structure. The program instructions execute according to a logic statement, such as represented by block 212 in FIG. 2B, as associated with a particular trace category. That is, in an executing program a trace symbol, written into the program by the program developer, may be received which identifies a particular trace category for tracing. The particular trace category identified as a bit string such as the predefined bit string 208 illustrated in FIG. 2B. Program instructions execute upon detecting a given predefined bit string to perform the logic statement routine 212 associated therewith.

Embodiment for a Conditional Associated with a Trace Category

FIG. 2D is an example embodiment which illustrates a logic statement for a TRACE_INFOFLOW trace category. According to embodiments described herein, the TRACE_INFOFLOW trace category can be provided as a trace symbol in a program, such as an SLP, written by a software developer. When, in an executing program, the TRACE_INFOFLOW trace category is identified, e.g., by a predefined bit string 208, the program instructions will execute to perform the logic statement shown in FIG. 2D.

According to the embodiments described herein, a trace category is bracketed as a conditional within the program written by the program developer. Thus, as described in connection with FIG. 2A, program instructions execute to test a conditional for determining which action, or function, to execute next, e.g., IF [trace category is enabled] THEN [execute a block of calls to appropriate trace routine]. The program instructions will execute as a function to check the Boolean value associated with the trace category as shown in DDL 214. Thus, in one Unix environment, the condition If [Trace.FUNCTION=true] (“function” being used as a generic label) will be used as a conditional to check, i.e., indicate, whether a system call tracing routine is enabled for that particular function, i.e., trace category before executing the block of calls to the appropriate trace routine.

As the reader will appreciate, in one Unix operating environment example, A TRACE_INIT procedure initializes the DDL based structure 214 with the bit values, 216-1, 216-2, . . . , 216-N, values associated with each trace category. In other words, the bit values serve as a bit mask, e.g., bit flags associated with various trace categories, indicating which categories are enabled. As a given TRACE procedure (e.g., TRACE_INT) expects a unique set of arguments including trace category, e.g., TRACE_INT(TRACE_INFOFLOW, “timeoutSec=”, timeoutSec, “Seconds”). In this example, following from above, TRACE_INFOFLOW is the trace category contained within the unique set of arguments.

As shown in the example embodiment of FIG. 2D, the trace category is bracketed as a conditional, e.g., IF [Trace.INFOFLOW=1], THEN [execute trace routine system call for Trace.INFOFLOW]. However, as illustrated in FIG. 2D, IF [Trace.INFOFLOW=0], THEN [do not execute trace routine system call for Trace.INFOFLOW]. As the reader will appreciate from this example, embodiments of the present invention involve bracketing only a single decision symbol, e.g., the conditional relating to whether the trace category (e.g., is true or false). Further, by virtue of using the predefined bit string 208, its associated logic statement 221 (illustrated in example fashion here in FIG. 2D), and the DDL based structure 214, embodiments of the present invention can test whether a tracing routine is enabled for a particular trace category without the use of an ANDing operation and before expending the resources of a system call. Thus, program instructions execute to check a conditional associated with a trace category by testing an associated Boolean value of a member variable of a DDL based structure before making a trace procedure system call. The Boolean value indicates, in advance of invoking the overhead of a system call, whether a tracing is enabled for the particular trace category. Thus, embodiments described herein improve program performance since a system call is not placed unnecessarily, i.e., a system call is not expended when a tracing is disabled.

If the particular trace category is enabled (e.g., 1 or “true”), the program instructions execute a block of system calls (also referred to as a “tracing system call” or “function call tracing”) to the appropriate trace routine. Shown in FIG. 2D as the action [execute trace routine system call for TRACE_INFOFLOW]. If, however, the particular trace category is not enabled (e.g., 0 or “false”), then the program instructions do not execute a tracing system call, e.g., illustrated as the action [do not execute trace routine system call for Trace.INFOFLOW]. The embodiments described herein eliminate the previous use of the ANDing operation by virtue of a set of Boolean variables in the control structure. One of ordinary skill in the art will further appreciate that this outer test (i.e., the trace category conditional) can be skipped for a given category if the overhead of making the call is permissible. Detail on the manner in which the embedded trace category conditional can be skipped is not described further herein so as not to obscure the embodiments of the invention.

Example Program Development and Use

FIG. 3A is a block diagram of a software development system 300 suitable for creating program embodiments described herein. One type of popular programming is modular programming, e.g., object oriented programming, which breaks down the design of a program into individual components (modules) that can be programmed and tested independently. FIG. 3A is discussed in reference to object oriented programming. C++ and Java are examples of object oriented programming languages. There are also various derivatives of C++ and Java used by software developers in the telecommunications field to provide service logic programs (SLPs) deployable in a service logic execution environment (SLEE). These various derivatives are referred to herein as service logic execution languages (SLELs). One of ordinary skill the art will appreciate the terms SLP, SLEE, and SLEL upon reading this disclosure. More discussion is not provided so as not to obscure aspects of the invention discussed below.

Specification and description language (SDL) is another modern, high level programming language which is object oriented, formal, and graphical. SDL can be compiled into other languages such as C++ using an SDL tool. And further, once the SDL tool has compiled the SDL language to C++, for example, a C++ compiler and linker can be used to further create an executable application including instructions originally written in the SDL language. One of ordinary skill in the art will recognize the SDL language and associated programming tools. For instance, one example of SDL programming tools is provided by the Telelogic TAU SDL suite of products offered by Telelogic North America, Inc. The Telelogic TAU SDL suite is based on the object oriented design language SDL and the trace language MSC (message sequence charts) both of which are internationally standardized.

Referring to FIG. 3A a program developer can write source code 301, (e.g., using C++ object oriented programming language) to develop a program, (e.g., an SLP for use in a wireless telecommunications network). Once the developer has written source code 301 for the program, the source code 301 is provided to an appropriate compiler 320 (e.g., C++ compiler) and linker utility 350 via an interface 310. As shown in FIG. 3A, the interface 310 can include both command-line driven 313 and Integrated Development Environment (IDE) 311 interfaces as the same are known and understood in the art. From the source code 301 and header and includes files 330 (also known and understood by one of ordinary skill in the art) the compiler 320 “compiles” or generates object modules 303, each containing one or more object files. The linker 350 next “links” or combines the object modules 303, each having one or more object files, with standard libraries 360 (e.g., graphics, I/O routines, startup code, and the like) to generate executable program(s) 305. As shown in FIG. 3A, the development system 300 can provide class libraries 365, e.g., C++ libraries, in addition to standard libraries 360.

According to various embodiments a program developer also writes source code 302, using a hybrid graphical/text language such as the above described SLEL in SDL, to create additional pieces to the program. For example, as illustrated in FIG. 3A, the program developer also writes source code 302 using a SLEL in SDL language, as the same will be recognized in the telecommunication arts, to create a DDL (as shown in FIG. 2C), to create a predefined bit string (as shown in FIG. 2B) representing a particular trace category, and to associate, i.e., embed, logic statements (as shown in FIG. 2D) with each of the predefined bit strings, i.e., embedding a logic statement including a conditional associated with each trace category.

As illustrated in the example embodiment of FIG. 3A, an SDL tool 304 (e.g., a programming tool as available in the Telelogic TAU SDL suite of products) is used to compile the SLEL in SDL source code into a language in which the other source code listings 301 for the program are written (e.g., C++). The translated SLEL in SDL code can then be similarly passed to the compiler 320 for compiling the code into object modules 303, each containing one or more object files and on to the linker, etc., as has been described above.

As shown in FIG. 3A, an executable program(s) 305 can be connected to a test controller 306 and a system under test (SUT) 307 in order to test program(s) 305. As programs are developed they are tested under a workload, e.g., a SUT, to ensure that the programs will function as intended. The executable programs 305 can be provided to a debugging module 370 for eliminating errors in the source code listings 301. The debugging module 370 can execute a set of software instructions in cooperation with a SUT 307 and test controller 306 to produce a diagnostic record 380 for an executable program 305.

As the reader will appreciate, the completed executable program 305 will include the program instructions and embodiments described above in connection with FIGS. 2A-2D. Such executable programs can then be delivered, or released, to customers.

FIG. 3B is a flowchart illustrating the continuance of a programs life cycle from the development environment in FIG. 3A to actual use in the customer's run time environment. The development environment portion of FIG. 3B mirrors the discussion which was provided in FIG. 3A. FIG. 3B exemplifies that executable programs, including SLPs developed according to the embodiments described herein (e.g., 305 in FIG. 3A), can be loaded onto a device to sell to a customer once the development environment process is complete. Likewise, the product can be shipped on disk to a customer and the customer can load the executable programs onto their system.

FIG. 3B is useful for illustrating program embodiments executing in the customer's run time environment. As illustrated in FIG. 3B, a system user can interact with an executing program 374 running on the customer system using such tools as a system user interface 371 and a customer “system file” 372. In this example, the executing program 374 includes the embedded tracing logic, i.e., conditionals associated with various tracing categories, as has been described above.

FIG. 3B, further illustrates that member variables, shown as 216-1, 216-2, . . . , 216-N in the DDL of FIG. 2C, can be accessible in a portion of user space (e.g., illustrated as 373 on the system file 372). According to embodiments, program instructions are provided in developing a given program which when executed can allow a system user to change a value of one or more of these member variables (e.g., from 1 “true” to 0 “false” and vice versa). These program instructions can be executed on demand, e.g., be executed by user input to the system user interface. These program instructions will also be executed upon each system start up to initialize the member variables with their respective trace categories in the DDL. One of ordinary skill in the art will further appreciate, the manner in which other portions of a tracing control structure, as the same will be known and understood by one of ordinary skill in the art, can be located in kernel space/data structures, or elsewhere in customer's. system, and be accessible by instructions executing as part of a “tracing system call” or “function call tracing”. Embodiments are not so limited. Thus, as shown in FIG. 3B, when a tracing routine for a given trace category is enabled a system user can retrieve information associated therewith in the form of a diagnostic report 375, or otherwise, as the same are known and understood by one of ordinary skill in the art.

Example System Network

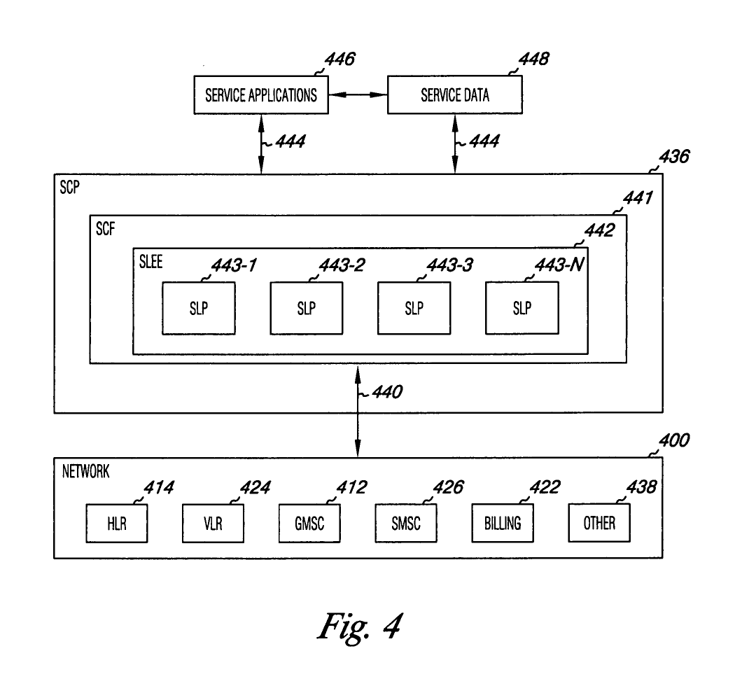

FIG. 4 is an example illustration of a system network, e.g., a wireless telecommunications network, showing the interaction between a number of network functions and service functions which can include program embodiments (exemplified here as service logic programs (SLPs)) having embedded tracing logic, i.e., conditionals associated with various tracing categories, as the same have been described herein. FIG. 4 is an example illustration of the interaction between a number of network functions and service functions. In FIG. 4, a number of functions within network 400 interact with a number of services provided through a service control point (SCP) 436. Network functions, e.g., home location register (HLR) 414, visitor location register (VLR) 424, gateway mobile switching center/controller (GMSC) 412, service mobile switching center/controller (SMSC) 426, billing 422, and other functions 438, can communicate requests for services including requests for data, communications between devices or networks, and the like, which will employ SLPs. These requests for services and the responses to such requests can be provided by a number of different protocols, such as intelligent network application part (INAP), mobile application part (MAP), customized applications for mobile network enhanced logic (CAMEL), and capability set (CS) protocols, etc. The requests are directed to the SCP 436 via transaction capabilities application part (TCAP) messages 440 to create a session, e.g., message exchange, with an SLP 443-1, 443-2, 443-3, . . . 443-N within a SLEE 442. The designator “N” is used to illustrate that a number of such SLPs can be created. The SLEE is an environment in which SLP instances are created. The SLEE 442 can provide the role of a service control function (SCF) 441 on the SCP 436.

A given SLP may connect via a communication link 444 with one of a number of service applications 446 and/or service data 448 to fulfill the requests for services. In some embodiments, service applications can be of various types and can be grouped based upon the type of services they provide. For example, Parlay service applications, as the same will be will be understood by one of ordinary skill in the art, or other such service application groups can be used.

Although specific embodiments have been illustrated and described herein, those of ordinary skill in the art will appreciate that an arrangement calculated to achieve the same techniques can be substituted for the specific embodiments shown. This disclosure is intended to cover adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for handling trace routines in a program, comprising:
providing a conditional associated with a trace category, the conditional to test whether a tracing is enabled for the trace category; and
checking the conditional before making a tracing system call.

2. The method of claim 1, wherein the conditional tests a value of a member variable of a data description language (DDL) based structure that indicates whether a trace category is enabled.

3. The method of claim 1, further including bracketing a single decision symbol associated with the trace category.

4. The method of claim 1, wherein the program is a service logic program (SLP).

5. The method of claim 4, further including embedding the logical statement in the SLP using a hybrid graphical/text language.

6. The method of claim 4, wherein the hybrid graphical/text language is a service logic execution language (SLEL) in specification and description language (SDL).

7. A method for handling trace routines in a service logic program (SLP), comprising:
embedding a conditional associated with a trace category in the SLP using a hybrid graphical/text language; and
disabling a tracing routine associated with the trace category on demand in a run time environment.

8. The method of claim 7, further including enabling a tracing routine associated with the trace category on demand in a run time environment.

9. The method of claim 7, wherein embedding a conditional associated with a trace category includes bracketing a trace category with a decision symbol.

10. The method of claim 7, further including associating a member variable with the trace category within a data description language (DDL) based structure, wherein the member variable is a bit value that indicates whether the tracing routine associated with the trace category is enabled.

11. The method of claim 10, further including executing the conditional to test a Boolean value of the member variable.

12. The method of claim 10, further including initializing the member variable at a system start up and when invoked by a system user.

13. A computer readable medium having a program to cause a device to perform a method, comprising:
accessing a conditional associated with a trace category; and
testing the conditional before making a tracing system call.

14. The medium of claim 13, wherein testing the conditional includes executing instructions to check a value of a variable associated with the trace category in a data description language (DDL) programming structure.

15. The medium of claim 14, further including embedding conditional in a service logic program SLP using a hybrid graphical/text language.

16. The medium of claim 15, wherein the hybrid graphical/text language is a service logic execution language (SLEL) in specification and description language (SDL).

17. The medium of claim 13, further including associating a variable with the trace category within a data description language (DDL) based structure, wherein the variable is a bit value that indicates whether a tracing routine associated with the trace category is enabled.

18. The medium of claim 17, further including executing the conditional to test a Boolean value of the variable.

19. The medium of claim 17, further including initializing the variable at a system start up and when invoked by a system user.

20. A network device, comprising:
a processor;
a memory coupled to the processor, the memory including a service logic program (SLP), wherein the SLP includes a conditional embedded in association with a trace category, the conditional to test whether a tracing routine associated with the trace category is enabled; and
wherein the SLP executes instructions to test the conditional before making a tracing system call.

21. The device of claim 20, wherein the conditional is embedded in the SLP using service logic execution language (SLEL) in specification and description language (SDL).

22. The device of claim 20, wherein the conditional tests a variable associated with the trace category within a data description language (DDL) based structure.

23. The device of claim 22, wherein the variable is initialized at a system start up and when invoked by a system user.

24. The device of claim 23, wherein the variable is modifiable in a customer environment.

25. The device of claim 20, wherein the conditional includes a single bracketed statement associated with the trace category.

26. The device of claim 20, wherein the device is a service control point (SCP) in a communication network, the SCP having program instructions associated with a service control function (SCF) executable within a multiple service logic execution environment (multi-SLEE).

27. A network system, comprising:
a network device, comprising:
a processor;
a memory coupled to the processor, the memory including a service logic program (SLP), wherein the SLP includes a conditional embedded in association with a trace category, the conditional to test whether a tracing routine associated with the trace category is enabled; and
wherein the SLP executes instructions to test the conditional before making a tracing system call; and
a user interface coupled to the network device, wherein the user interface provides access to a variable associated with the trace category within a data description language (DDL) based structure, the variable indicating whether a tracing routine associated with the trace category is enabled.

28. The system of claim 27, wherein system includes program instructions which can execute to initialize the variable when invoked by input to the user interface and at a system start up.

29. The system of claim 28, wherein the program instructions can execute to change the variable based on input to the user interface.

30. The system of claim 27, wherein the conditional is embedded in the SLP using service logic execution language (SLEL) in specification and description language (SDL).

31. A network device, comprising:
a processor;
a memory coupled to the processor, the memory including a service logic program (SLP) having a conditional embedded in association with a trace category;
a user interface coupled to the network device, and
means for testing the conditional to determine whether a tracing routine associated with the trace category is enabled prior to executing a tracing system call.

32. The device of claim 31, wherein the means includes a set of computer executable instructions.

33. The device of claim 31, wherein the means includes a variable associated with the trace category in a data description language (DDL) based structure, the variable indicating whether a tracing routine associated with the trace category is enabled.

34. The device of claim 31, wherein the means includes a predefined bit string associated with a logic statement including the conditional.
